(19) United States
(12) Patent Application Publication
(10) Pub. No.: US 2022/0149573 A1
(43) Pub. Date: May 12, 2022

(54) FLOOR-MOUNTED TRACK FOR INSTALLATION OF POWER OUTLET MODULES

(71) Applicant: EMOOV, LLC, Sanford, NC (US)

(72) Inventors: Debra RAFFERTY, Sanford, NC (US); Frank VALE, Sanford, NC (US)

(21) Appl. No.: 17/584,633

(22) Filed: Jan. 26, 2022

Related U.S. Application Data
(63) Continuation-in-part of application No. 17/153,677, filed on Jan. 20, 2021.
Application No. 17/153,677 is a continuation-in-part of application No. PCT/US2019/042529, filed on Jul. 19, 2019.
(60) Provisional application No. 62/752,765, filed on Oct. 30, 2018.
(60) Provisional application No. 62/701,207, filed on Jul. 20, 2018.

(51) Int. Cl. H01R 25/14; H01R 13/514; H01R 13/518

(52) U.S. Cl. CPC H01R 25/14; H01R 13/518; H01R 13/514

(57) ABSTRACT

A floor-mounted track for mechanical and electrical engagement of a removable electrical power outlet module includes a bottom ran, a first rail positioned parallel the bottom rail, a first electrode engaged with the first rail and extending along at least a portion of a length of the first rail, a second rail positioned parallel the bottom rail and spaced a distance from the first rail to define a slot between a slot side of the first rail and a slot side of the second rail, a second electrode engaged with the second rail and extending along at least a portion of a length of the second rail, a first wall connecting a first side of the bottom rail to a connected side of the first rail opposite the slot side of the first rail, and a second connecting a second side of the bottom rail to a connected side of the second rail opposite the slot side of the second rail.

### BACKGROUND

There is a need in the field for improvements to the conventional home or commercial electrical power distribution system to make it more convenient, widely available, and cost-effective.

### SUMMARY OF THE INVENTION

The present disclosure provides systems including tracks for installation of power outlet modules. Tracks may be installed flush with a floor to minimize distraction and/or negative effect on the esthetics of the space, reduce trip hazards, and provide convenient access to electrical power. Moreover, the locking mechanism disclosed herein to secure the power modules to the tracks or assemblies require no tools and only minimum manipulation by a user and are, thus, convenient to install, remove, or adjust. In addition, the systems disclosed herein provide safe and secure mechanical and electrical connection between the power outlet modules and the tracks while keeping the systems convenient and cost-effective.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1A illustrates an exemplary power outlet module having a receptacle as a power outlet.

FIG. 1B illustrates an exemplary power outlet module having two universal serial bus (USB) ports as power outlets.

FIG. 2 illustrates a perspective view of an exemplary track.

FIG. 3 illustrates an exemplary moulding member.

FIG. 4 illustrates an exemplary engagement of the moulding member with the track.

FIG. 5 illustrates an exemplary installation of the track within a floor channel of a carpeted floor.

FIG. 6 illustrates an exemplary installation of the track within a floor channel of a concrete floor.

FIG. 7 illustrates a perspective view of an exemplary connection portion.

FIG. 8 illustrates another perspective view of the connection portion.

FIG. 9 illustrates a perspective view of an exemplary transition portion.

FIG. 10 illustrates a perspective view of an exemplary installation of the connection portion with the transition portion.

FIG. 11 illustrates a perspective view of another exemplary installation of the connection portion with the transition portion.

FIGS. 12A and 12B illustrate perspective views of an exemplary power input portion.

FIG. 13A illustrates a partial perspective view of the power input portion.

FIG. 13B illustrates a perspective view of an exemplary front plate of the power input portion.

FIG. 14 illustrates a partial perspective view of an exemplary engagement of the connection portion with the transition portion where the connection portion is in position to be engaged with the power input portion.

FIG. 15 illustrates a partial perspective view of the power input portion, the connection portion, and the transition portion.

FIG. 16 illustrates a perspective view of an exemplary plate member.

FIG. 17 illustrates a perspective view of an exemplary installation environment including a junction box and the plate member.

FIG. 18 illustrates a perspective view of the plate member engaged with the junction box.

FIG. 19 illustrates a partial perspective view of the power input portion showing a lever of the power input portion.

FIG. 20 illustrates a partial perspective view of the power input portion shown a notch of the power input portion.

FIGS. 21A and 21B illustrate perspective views of an exemplary end cap portion.

FIG. 22 illustrates a perspective view of an exemplary engagement of the end cap portion with the track.

FIGS. 23A and 23B illustrate perspective views of exemplary intersection portions.

FIGS. 24A and 24B illustrate perspective views of other exemplary intersection portions.

FIG. 25 illustrates a perspective view of a power outlet module.

FIG. 26 illustrates a perspective view of the power outlet module and the track before the power outlet module is inserted into the slot of the track.

FIG. 27 illustrates a perspective view of the power outlet module and the track after the power outlet module is inserted into the slot of the track.

FIG. 28 illustrates a perspective view of an exemplary data track with data transmission equipment received in an interior channel of the data track.

FIG. 29A-29D illustrate perspective views of conventional register jack 45s (RJ45s).

FIG. 30 illustrates a perspective view of the RJ45 installed on a cover portion of the data track.

FIG. 31 illustrates a perspective view of the data track engaged with the track and installed within a floor channel of a floor.

### DETAILED DESCRIPTION

### Floor Track System

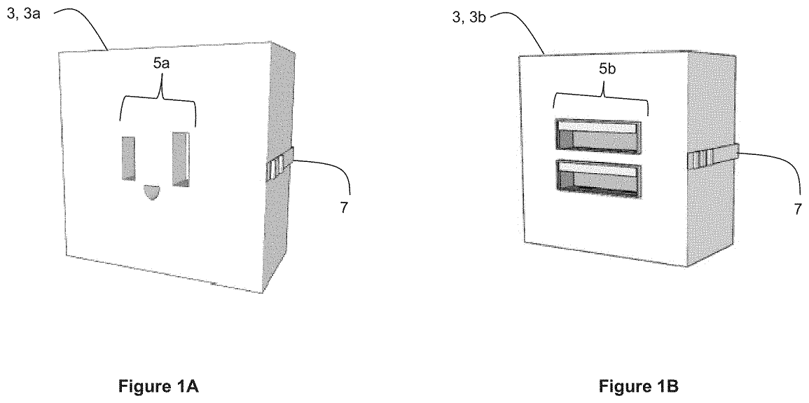

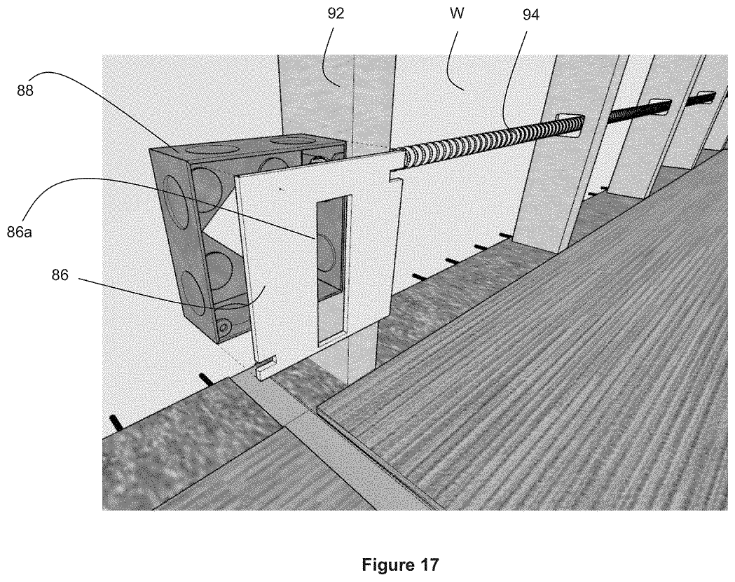

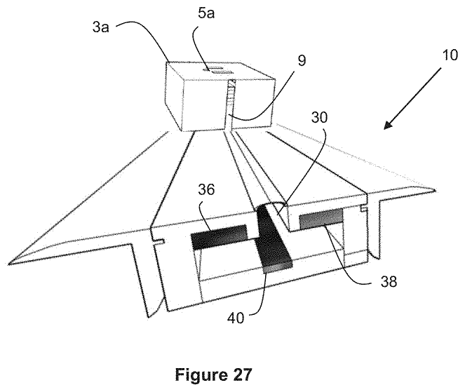

FIG. 1A through FIG. 31 illustrate perspective views of a system 1 for mechanical and electrical engagement of a power outlet module 3 to a floor F. The power outlet module 3 may be any module that provides power (AC or DC) to operate pluggable powered devices.

The power outlet module 3 may include or have built thereon one or more standard AC mains power outlet configurations (e.g., NEMA 1-15 Type A, NEMA 5-15 Type B, JIS C 8303 Class I and II, CEE 7/1, CEE 7/3, CEE 715, etc.). FIG. 1A illustrates a first type of power outlet module 3a having a receptacle 5a as a power outlet 5a and FIG. 1B illustrates a second type of power outlet module 3b having two universal serial bus (USB) ports 5b as power outlets.

As described below, the system 1 provides convenient installation of the power outlet module 3 to the floor. To accomplish this, the system 1 may include a track 10 that may be installed flush (i.e., within), or substantially flush (i.e., substantially within) with the floor F. As such, in some implementations, the track 10 may be installed within, or substantially within, the floor F during new construction or existing construction.

### Track

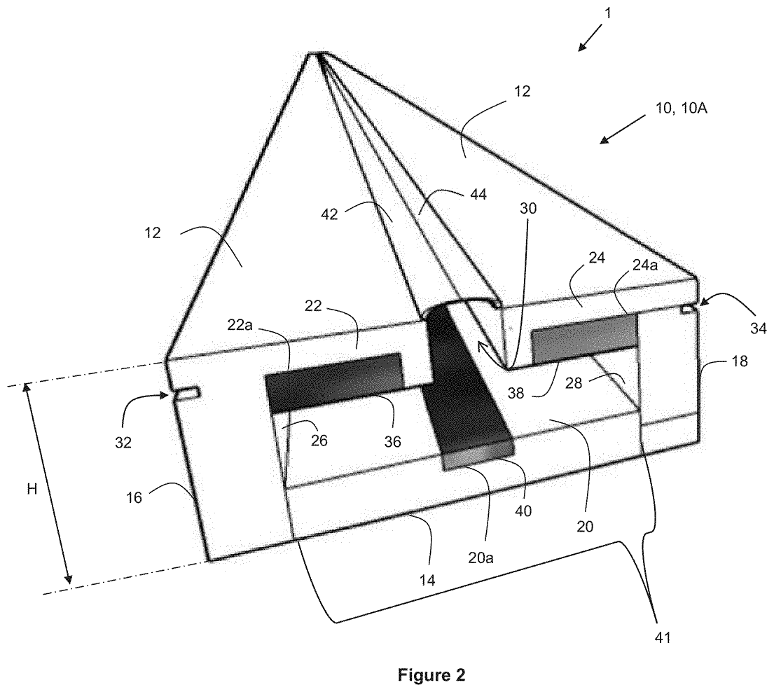

FIG. 2 illustrates a perspective view of an exemplary track 10. The track may include a top surface 12, a bottom surface 14, a first side wall 16, a second side wall 18, a bottom rail 20, a first top rail 22, a second top rail 24, a first inner side wall 26, and a second inner side wall 28.

The top surface 12, the first top rail 22 and the second top rail 24 may define a slot 30 extending along a length of the track 10. The first side wall 16 may define a first notch 32 extending along a length thereof and the second side wall 18 may define a second notch 34 extending along a length thereof. The first inner side wall 26 may be positioned between the bottom rail 20 and the first top rail 22 and the second inner side wall 28 may be positioned between the bottom rail 20 and the second top rail 24.

The track 10 may further include a first electrode 36, a second electrode 38, and a third electrode 40. The first electrode 36 may be engaged with the first top rail 22 extending along a length thereof, the second electrode 38 may be engaged with the second top rail 24 extending along a length thereof, and the third electrode 40 may be engaged with the bottom rail 20 extending along a length thereof. More particularly, the first electrode 36 may be engaged with a bottom surface 22a of the first top rail 22, the second electrode 38 may be engaged with a bottom surface 24a of the second top rail, and the third electrode 40 may be engaged with a top surface 20a of the bottom rail 20.

The first electrode 36, the second electrode 38, and the third electrode 40 may be elongated conductors, such as, for example, elongated copper conductors, elongated aluminum conductors, etc. The first electrode 36 may be a positive electrode, the second electrode 38 may be a negative electrode, and the third electrode 40 may be a ground electrode 40. The first electrode 36, the second electrode 38, and the third electrode 40 may be connected to a circuit, such as, for example, a power circuit that may provide power to power outlet modules 3 installed within the track 10. The first and electrode 36 and the second electrode 38 may also correspond to, for example, positive and negative signals of an audio stereo output, etc.

The track 10 may be made of a polyvinyl chloride (PVC) material such that the first electrode 36 may be embedded in, and surrounded by, at least a portion of the first top rail 22, the second electrode 38 may be embedded in, and surrounded by, at least a portion of the second top rail 24, and the third electrode 40 may be embedded in, and partially surrounded by, at least a portion of the bottom rail 20. One exemplary benefit of this configuration is improved safety as the first electrode 36, the second electrode 38, and the third electrode 40 are substantially covered to prevent a person from inadvertently making contact with a live electrode.

With continued reference to FIG. 2, the track 10 may include a first guard member 42 and a second guard member 44. The first guard member 42 may be engaged with the track 10 on one side of the slot 30 and the second guard member 44 may be engaged with the track 10 on an opposing side of the slot 30. The first guard member 42 and the second guard member 44 may extend along a length of the slot 30 and toward one another to cover, or substantially cover, the slot 30 along a length of the top surface 12. The first guard member 42 and the second guard member 44 may be made of a flexible material, such as, for example, rubber or polyester, which may allow selectable access to the slot 30 and may prevent undesirable materials (e.g., debris) from passing through the slot 30.

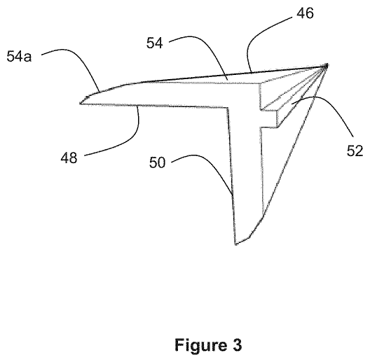

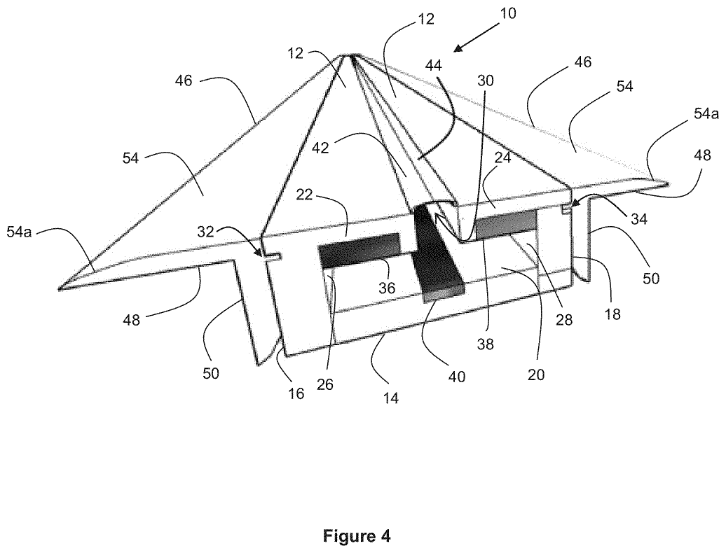

FIG. 3 and FIG. 4 illustrate an exemplary moulding member 46 and an exemplary engagement of the moulding member with the track. Accordingly, the track 10 may further include, if desired, moulding members 46 that may be engaged on opposing sides of the track 10. Each of the moulding members 46 may include a first engaging surface 48, a second engaging surface 50, an engaging member 52, and a top surface 54, each of which may extend along a length thereof. The engaging member 52 of one moulding portion 46 may be receivably engaged within the first notch 32 and the engaging member 52 of a different moulding portion 46 may be receivably engaged within the second notch 34. The top surface 54 may further include a tapered portion 54a that tapers downward to meet an edge of the first engaging surface 48.

As shown in FIG. 4, when the moulding members 46 are engaged with the track 10, the first engaging surface 48 of each of the moulding members 46 may face a direction vertically downward toward the bottom surface 14 of the track 10, and the second engaging surface 50 of each of the moulding members 46 may face a direction perpendicular to the first engaging surface 48 and away from the track 10, respectively.

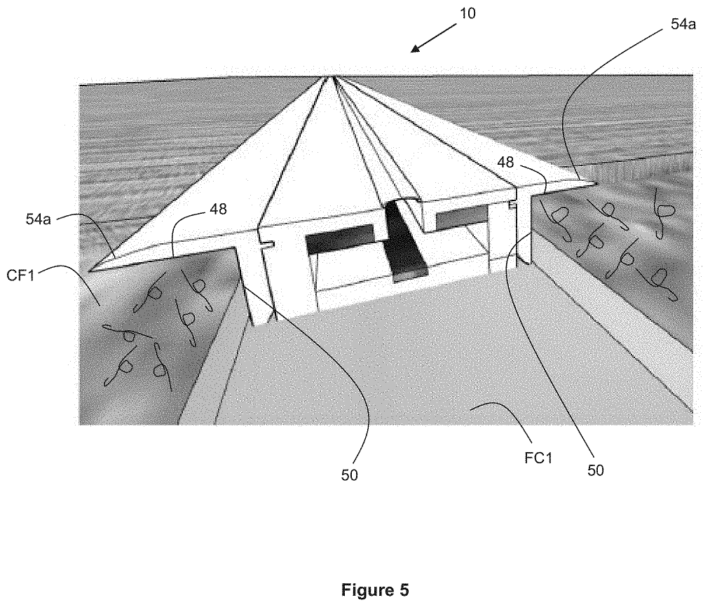

The moulding members 46 may be used to improve a transition between portions of the track 10 and portions of the floor F. FIG. 5 illustrates an exemplary installation of the track within a floor channel of a carpeted floor. In the example of FIG. 5, the track 10 may be positioned within a floor channel FC1 of a carpeted floor CF1 such that the first engaging surface 48 of each of the moulding members 46 engages a top surface of the carpeted floor CF1 and the second engaging surface 50 of each of the moulding members 46 engages a side surface of the floor channel FC1. The moulding members 46 may improve the transition between portions of the track 10 and portions of the top surface of carpeted floor CF1. More particularly, the tapered portions 54a of each of the moulding members 46 may provide a smooth transition from the track 10 to the top surface of the carpeted floor CF1.

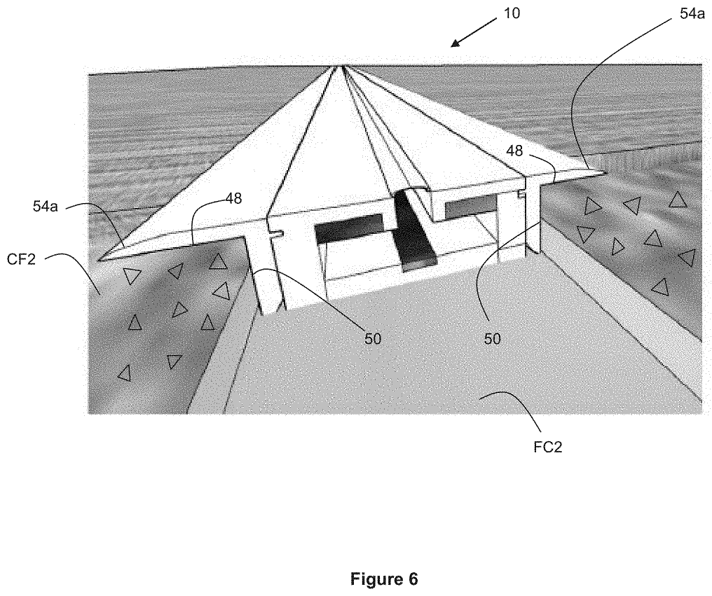

FIG. 6 illustrates an exemplary installation of the track within a floor channel of a concrete floor. In the example of FIG. 6, the track 10 may be positioned within a floor channel FC2 of a concrete floor CF2 such that the first engaging surface 48 of each of the moulding members 46 engages a top surface of the concrete floor CF2 and the second engaging surface 50 of each of the moulding members 46 engages a side surface of the floor channel FC2. The tapered portions 54a of each of the moulding members 46 may provide a smooth transition from the track 10 to the top surface of the concrete floor CF2.

Additionally, the track 10 may have a height H (FIG. 2) of less than 1 inch and, after being installed within at least a portion of the floor F, the track 10 may extend above a plane of the floor F less than 0.0625 inches allowing the track 10 to maintain a low profile. Some exemplary advantages of this configuration include cost savings and safety improvements. For example, with such a low profile, the track may be installed within a micro-channel in a concrete slab floor eliminating the need for core drilling, which is expensive and time consuming. Further, the low profile of the track 10 may prevent a person from tripping over portions of the track 10.

### Connection, Power, and Transition Track Portions

The track 10 may include various portions, such as, for example, track portions related to providing connections between track portions, providing power to track portions, and providing transitions between track portions. To accomplish this, each of the various portions may include portions of the track 10 as further described below.

For example, the track may include a number of power track portions 10A, which may include substantially identical components as the components of the track, however, the power track portions may be connected to one another until a desired or maximum length of the overall track 10 is reached. This way power may travel through the track 10 from the AC mains connected to the rear terminal block 76 to the power outlets of the power outlet modules 3 installed to the power track portions 10.

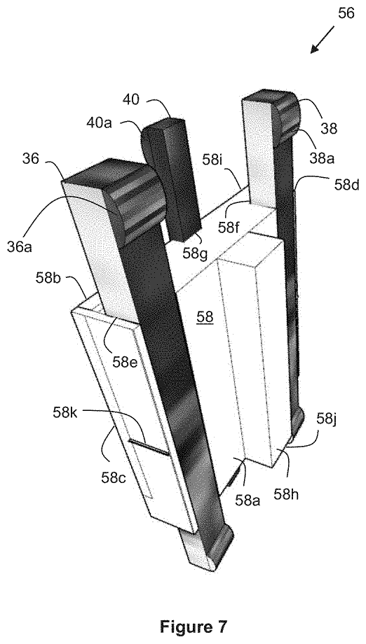

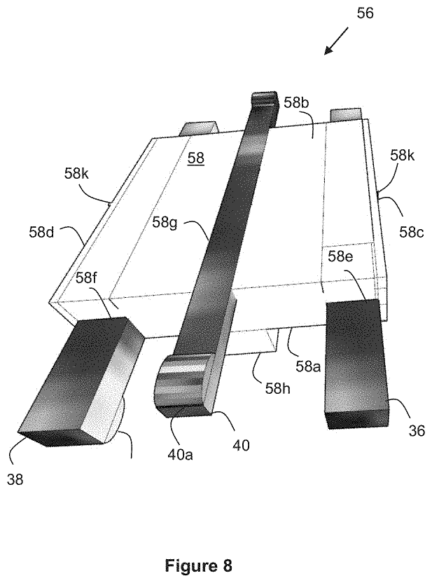

FIG. 7 and FIG. 8 illustrate perspective views of an exemplary connection portion 56. The connection portion 56 may provide a connection between other portions of the track 10, The connection portion 56 may include respective portions of the first electrode 36, the second electrode 38, the third electrode 40, and a body 58. The respective portions of the first electrode 36, the second electrode 38, and the third electrode 40 may include connectors 36a, 48a, and 40a, respectively, for engaging the first electrode 36, the second electrode 38, and the third electrode 40 of other portions of the track 10. The body 58 may include a top surface 58a, a bottom surface 58b, a first side 58c, a second side 58d, a first channel 58e, a second channel 58f, a third channel 58g, an elongated portion 58h, a first end 58i, a second end 58j, and a retaining notches 58k.

The first channel 58e may be defined by the top surface 58a proximate the first side 58c of the body 58 and may extend along a length thereof. The second channel 58f may be defined by the top surface 58a proximate the second side 58c of the body 58 and may extend along a length thereof. The third channel 58g may be defined by the bottom surface 58a between the first channel 58e and the second channel 58f and may extend along a length of the body 58. The elongated portion 58h may be provided on the top surface 58a of the body between the first channel 58e and the second channel 58f and may extend along a length of the body 58.

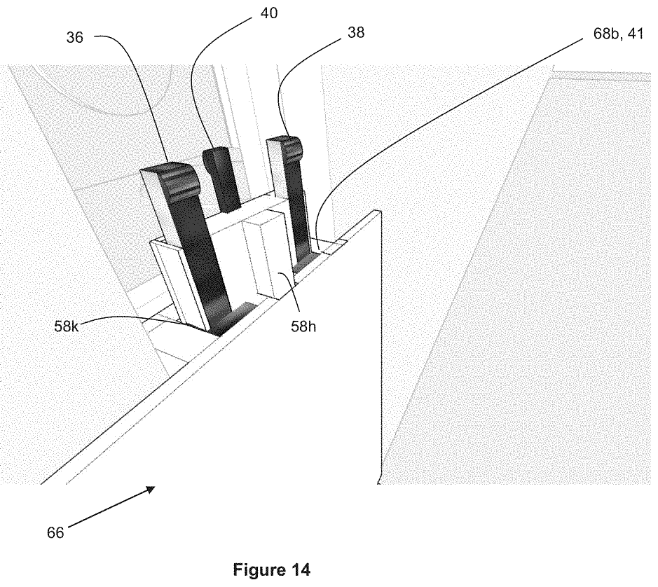

The respective portion of the first electrode 36 may be receivably engaged within the first channel 58e, the respective portion of the second electrode 38 may be receivably engaged within the second channel 58f, and the respective portion of the third electrode 40 may be receivably engaged within the third channel 58g. The respective portions of the first electrode 36, the second electrode 38, and the third electrode 40 may extend beyond the first end 58i and the second end 58j of the body 58. The retaining notches 58k stop the connection portion 56 from sliding into other portions of the track 10, as best shown in FIG. 14.

Accordingly, the respective portions of the first electrode 36, the second electrode 38, and the third electrode 40 may be electrically connected to respective portions of the first electrode 36, the second electrode 38, and the third electrode 40 of other track portions.

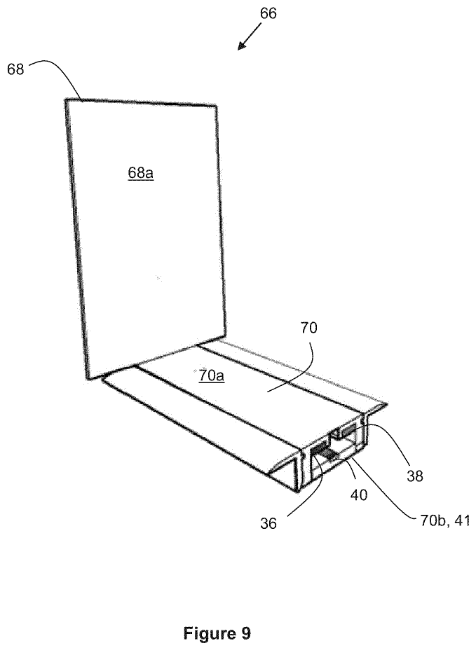

FIG. 9 through FIG. 11 illustrate perspective views of an exemplary vertical transition portion 66 and exemplary connections of the vertical transition portion to the connection portions 56. The vertical transition portion 66 may provide vertical transitions between different portions of the track 10 (e.g., the vertical transition portion 66 may provide a transition between a track portion having a length running in a first direction and a track portion having a length running in a second direction that is vertically orthogonal relative to the first direction). The vertical transition portion 66 may include a first section 68 and a second section 70. The first section 68 may include a front surface 68a and a rear portion 68b. The rear portion 68b may have an interior construction that is substantially identical to the interior construction of the track 10.

The second section 70 may include a top surface 70a and a bottom portion 70b. The second section 70 may have an exterior construction and an interior construction that are substantially identical to the exterior construction and the interior construction of the track 10.

The first section 68 may be engaged with the second section 70 such that the first section 68 extends vertically upward away from the top surface 70a of the second section 70. The front surface 68a of the first section 68 may be substantially orthogonal to the top surface 70a of the second section 70. Respective portions of the first electrode 36, the second electrode 38, and the third electrode 40 of the first section 68 and the second section 70 may be electrically connected with one another.

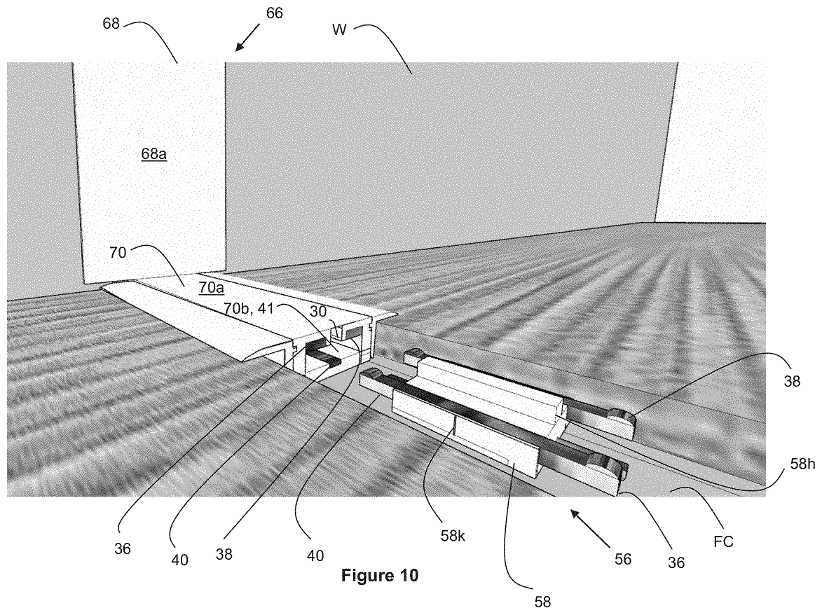

As shown in FIG. 10, the vertical transition portion 66 may be positioned such that the front surface 68a may be substantially flush with a wall W and the second section 70 may be positioned within a floor channel FC of a floor F. One connection portion 56 may be inserted within the bottom portion of the second section 70 and another connection portion 56 may be inserted within the rear portion 68 of the first section 68.

More particularly, the connection portion 56 may be inserted within the bottom portion 70b of the second section 70 such that the elongated member 58h is received within at least a portion of the slot 30 of the bottom portion 70b and the respective portions of the first electrode 36, the second electrode 38, and the third electrode 40 of the connection portion 56 and the bottom portion 70b are electrically connected to one another.

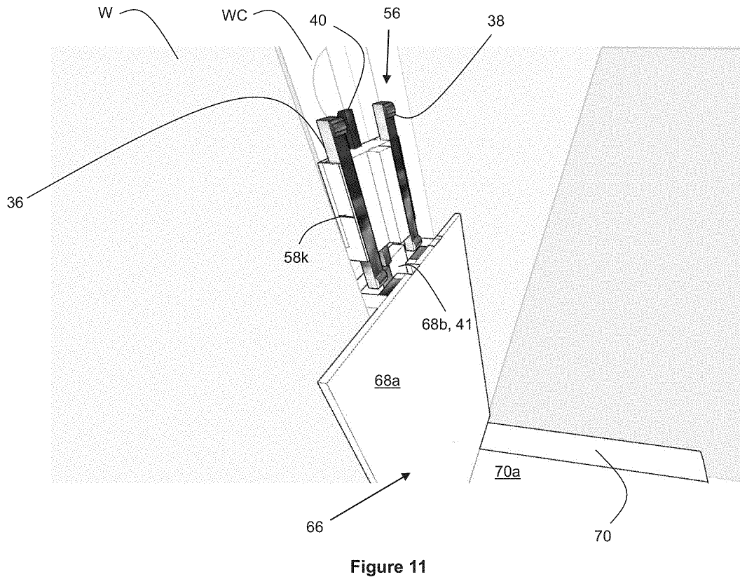

As shown in FIG. 11, the connection portion 56 may be inserted within the rear portion 68b of the first section 68 such that the elongated member 58h is received within at least a portion of the slot 30 of the rear portion 68b and the respective portions of the first electrode 36, the second electrode 38, and the third electrode 40 of the connection portion 56 and the rear portion 68b are electrically connected to one another.

The respective portions of the first electrode 36, the second electrode 38, and the third electrode 40 of the rear portion 68b may extend in a first direction and the respective portions of the first electrode 36, the second electrode 38, and the third electrode 40 of the bottom portion 70b may extend in a second direction. The first direction may be different than the second direction (e.g., vertically orthogonal to one another). The respective portions of the first electrode 36, the second electrode 38, and the third electrode 40 of the rear portion 68b may be coplanar with the respective portions of the first electrode 36, the second electrode 38, and the third electrode 40 of the bottom portion 70b.

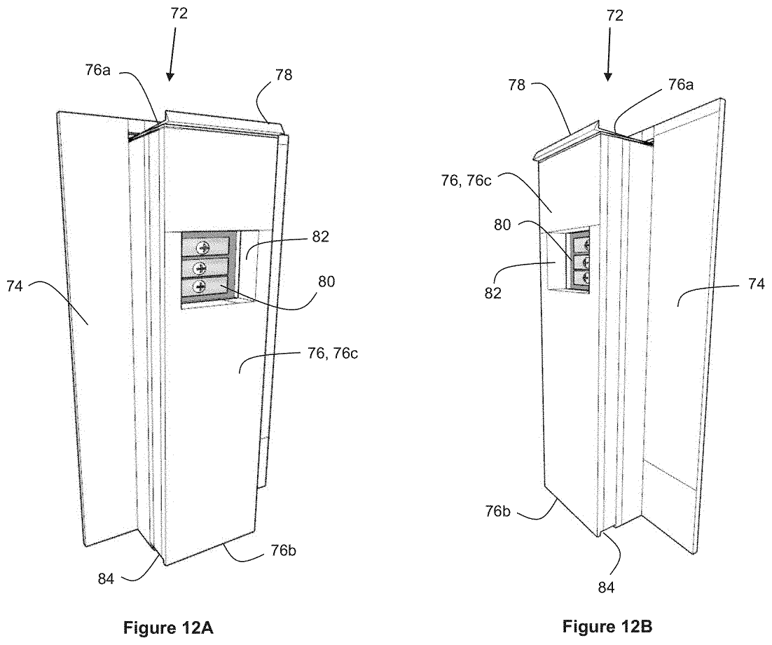

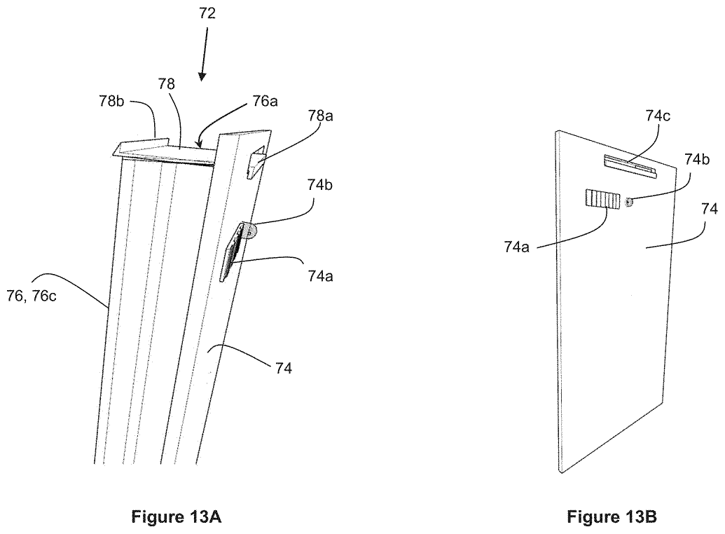

FIG. 12A through FIG. 13B illustrate perspective views of an exemplary power input portion 72, which may also be referred to as a wirebase. The power input portion 72 may be electrically connected to a power supply, such as, for example, a standard AC mains power supply and to other portions of the track 10 to provide power to the other portions of the track 10.

The power input portion 72 may include a front plate 74 and a rear terminal block 76. The front plate 74 may include a breaker 74a and a light-emitting diode (LED) power indicator 74b. The rear terminal block 76 may include a top end 76a, a bottom end 76b, and a rear surface 76c, The rear terminal block 76 may further include a lever 78 at the top end 76a. As best seen in FIG. 13A, the lever 78 may include a leveraging portion 78a and a latching portion 78b. The latching portion 78b releasably engages the plate member 86. The leveraging portion 78a may be manipulated via a vertically upward force to release the portion 78b and hence the power input portion 72 from the plate member 86. The leveraging portion 78a may protrude through a notch 74c of the front plate 74. The real terminal block 76 may further include wire terminals 80 positioned within a recess 82 defined by the rear surface 76c, and a notch 84 defined by the bottom end 76b. The rear terminal block 76 may have an interior construction that is substantially identical to the interior construction of the track 10.

The wire terminals 80 of the rear terminal block 76 may be electrically connected to power wires, such, as, for example, power wires connected to standard AC mains power. FIG. 14 illustrates a perspective view of an exemplary connection between the connection portion 56 and the rear portion 68b where the connection portion 56 is fully inserted within the rear portion 68b and respective portions of the first electrode 36, the second electrode 38, and the third electrode 40 are ready to be inserted within the rear terminal block 76 of the power input portion.

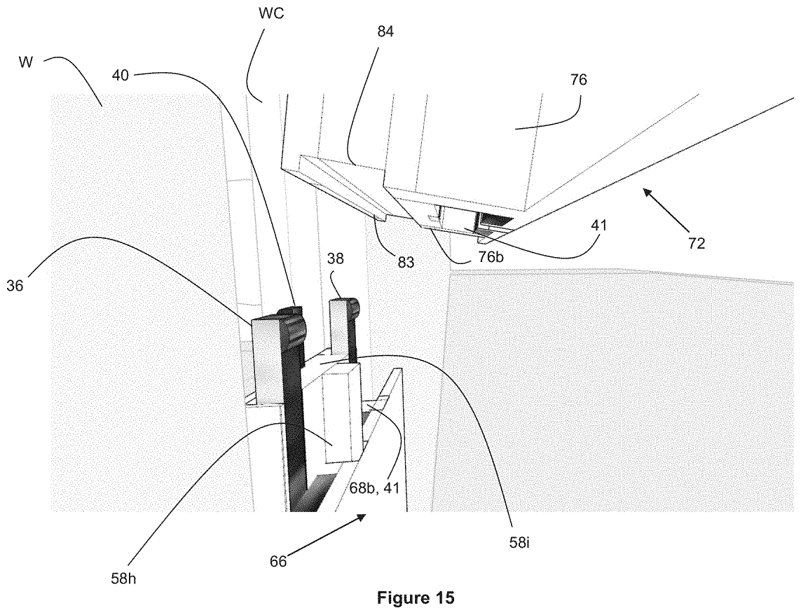

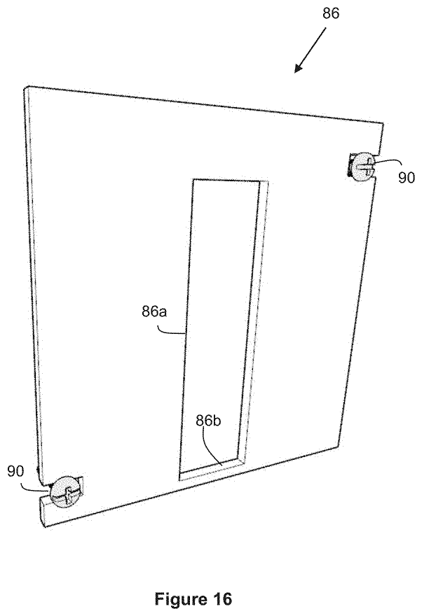

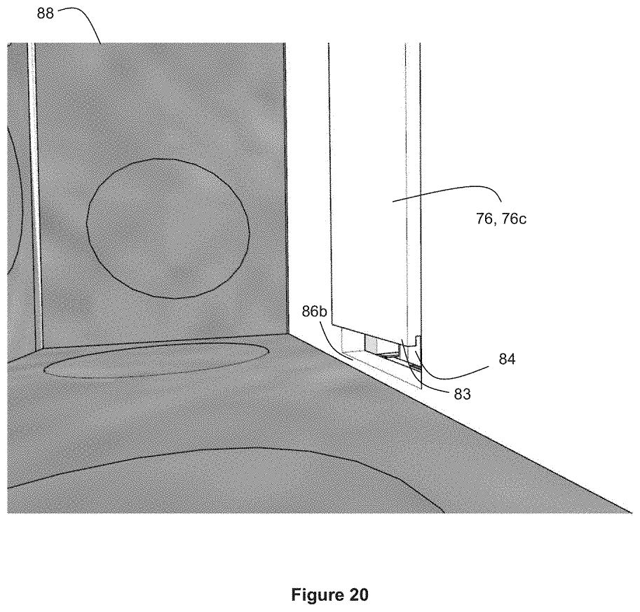

FIG. 15 illustrates a perspective view of an exemplary connection between the connection portion 56, the rear portion 68b, and the rear terminal block 76 of the power input portion 72. The rear terminal block 76 maybe engaged with the connection portion 56 such that the elongated member 58h is inserted within at least a portion of the slot 30 of the rear terminal block 76 and such that the respective portions of the first electrode 36, the second electrode 38, and the third electrode 40 of the connection portion 56 and the rear portion 68b are electrically connected to one another. The rear terminal block 76 may also include a locking flange 83 to lock the bottom 76b of the terminal block 76 to the bottom 86b of the plate member 86 (see FIGS. 16 and 20).

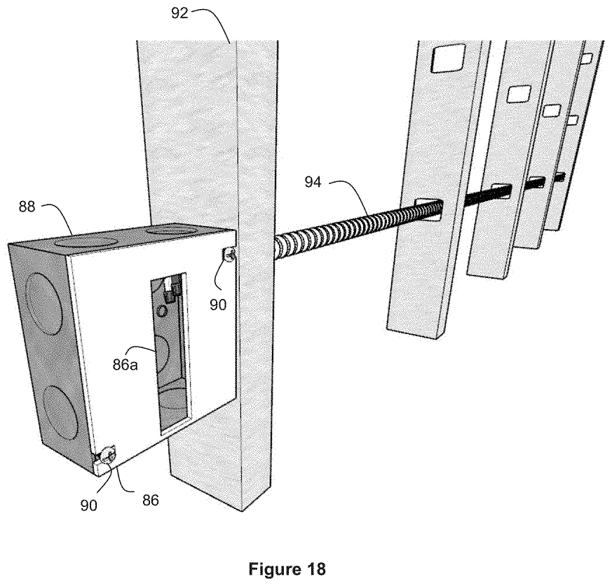

FIG. 16 through FIG. 18 illustrate perspective views of a plate member 86 and an exemplary installation engagement of the plate member 86 with the junction box 88. The plate member 86 may define an opening 86a extending therethrough and sized to receivably engage at least the rear terminal block 76 of the power input portion 72. More particularly, the plate member 86 may be engaged with the junction box 88 via fasteners 90 such that the plate member 86 is positioned at a front of the junction box 88 (FIG. 18). The junction box 88 may be positioned within a wall (i.e., proximate a stud 92 of a wall W) and power wires in electrical communication with the AC mains power supply may travel from the AC mains power supply through a conduit 94 to the junction box 88.

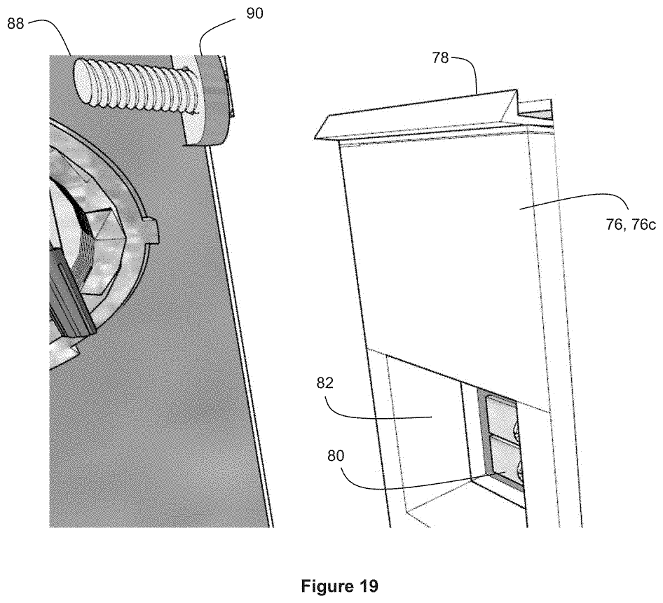

FIG. 19 through FIG. 20 illustrate partial perspective views of an exemplary installation of the power input portion 72 within the junction box 88 via engagement with the plate member 86. The power input portion 72 may be engaged with the plate member 86 such that the lever 78 releasably engages at least a portion of the plate member 86 (FIG. 19) and such that the notch 84 releasably engages at least a portion of the plate member 86 (FIG. 20). The lever 78 and specifically the portion 78a may be manipulated via a vertically upward force to release the portion 78b and hence the power input portion 72 from the plate member 86. The power wires from the AC mains power supply may be electrically connected to the wire terminals of the rear terminal block 76.

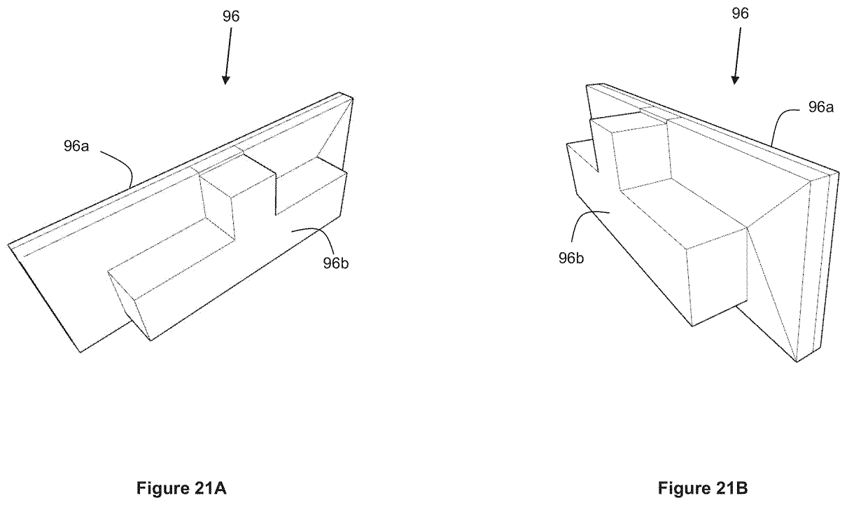

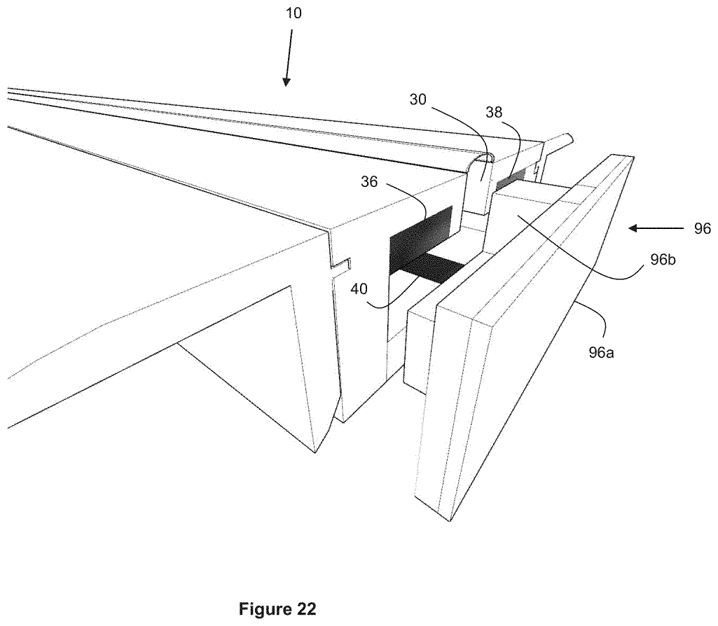

FIG. 21A through FIG. 22 illustrate perspective views of an exemplary end cap portion 96. The end cap portion 96 may enclose an end portion of another track portion of the track 10. The end cap portion 96 may include a body 96a and an insertion portion 96b. As such, the insertion portion 96b may take on a shape complementary to the interior construction of the track 10 (e.g., as shown in FIG. 22, the insertion portion 96b may extend within at least a portion of the slot 30 and may extend within areas below the first electrode 36 and the second electrode 38 and above the third electrode 40 of the track 10).

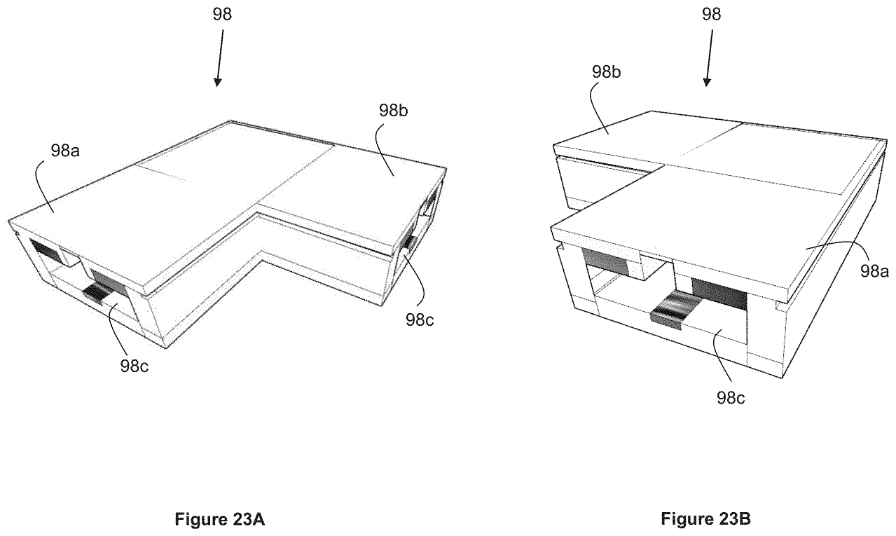

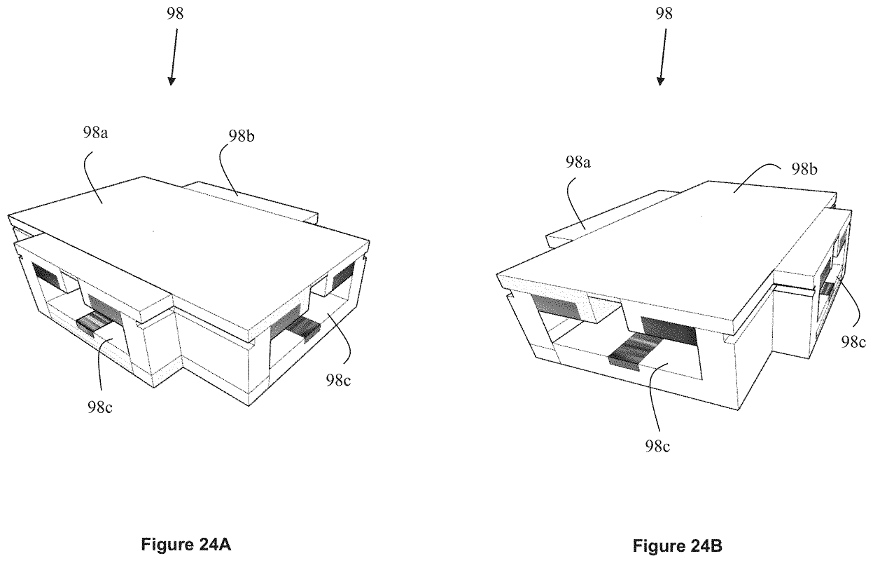

FIG. 23A through FIG. 24B illustrate perspective views of exemplary intersection portions 98. Each of the intersecting portions 98 may include a first section 98a and a second section 98b. The first section 98a and the second section 98b each may have an interior construction that is substantially identical to the interior construction of the track 10. The respective portions of the first electrode 36, the second electrode 38, and the third electrode 40 of the first section 98a may extend in a first direction and the respective portions of the first electrode 36, the second electrode 38, and the third electrode 40 of the second section 98a may extend in a second direction that is perpendicular to the first direction (e.g., horizontally orthogonal relative to one another).

The first section 98a and the second section 98b each may have one or two access points 98c. For example, if the first section 98a has one access point 98c and the second section 98b has one access point 98c, the first section 98a and the section 98b may be used to change a direction of a track portion relative to another track portion near a corner of a room (e.g., provide a 90 degree turn to traverse the corner of the room). If the first section 98a and the second section 98b each have two access points 98c, the first section and the second section 98b may be used as a hub in a central location of a room to connect four different track portions.

The first section 68 may be engaged with the second section 70 such that the first section 68 extends vertically upward away from the top surface 70a of the second section 70. The front surface 68a of the first section 68 may be substantially orthogonal to the top surface 70a of the second section 70. Respective portions of the first electrode 36, the second electrode 38, and the third electrode 40 of the first section 68 and the second section 70 may be electrically connected with one another.

### Powered Outlet Module and Installation

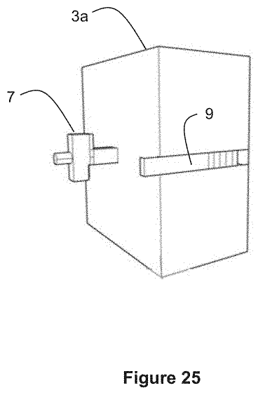

FIG. 25 through FIG. 27 illustrate installation of the power outlet module 3a. As shown in FIG. 25, the power outlet module 3a may further include a stem 7 and a locking mechanism 9. The stem 7 may include stem electrodes 7a (e.g., electrodes corresponding to positive, negative, and ground) that may be electrically coupled to the first electrode 36, the second electrode 38, and the third electrode 40.

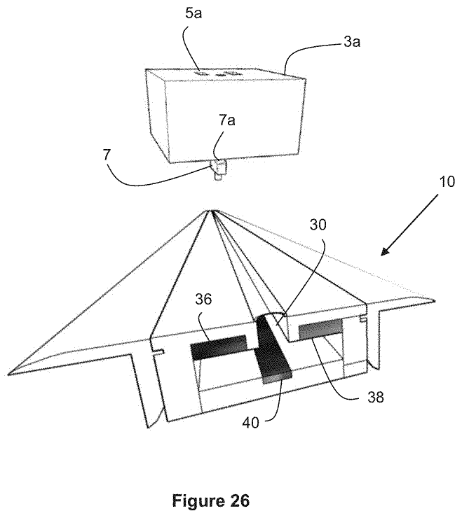

With the power outlet module 3a in the orientation shown in FIG. 26, the stem 7 may contact the first guard member 42 and the second guard member 44 causing the first guard member 42 and the second guard member 44 to allow access into the slot 30. The power outlet module 3a may be installed at any desired location along the track 10. The power outlet module 3a may be rotated such that the stem electrodes 7a engage the first electrode 36, the second electrode 38, and the third electrode 40 of the track 10.

Simultaneous pressure of the stem electrodes 7a against the first electrode, 36, the second electrode 38, and the third electrode 40 may mechanically create a locking, spring-like, effect of the power outlet module 3a to the track 10. This simultaneous pressure also provides adequate electrical connection between the stem electrodes 7a and the first electrode 36, the second electrode 38, and the third electrode 40. The locking mechanism 9 may slide forward to engage a portion of the track 10 (e.g., a side of the slot 30). Engagement of the locking mechanism 9 to the portion of the track 10 may prevent rotation of the power outlet module 3a. The locking mechanism 9 may be spring loaded to make engagement easier.

Removal or reinstallation of the power outlet module 3a is just as convenient. The locking mechanism 9 may be disengaged from the portion of the track 10 to allow rotation of the power outlet module 3a. The user may then rotate the power outlet module 3a in a direction opposite to the direction described above to disengage the stem electrodes 7a from the first electrode 36, the second electrode 38, and the third electrode 40. The user may then simply remove the power outlet module 3a from the track 10 or slide the power outlet module 3a to any desired position along the track 10 for installation at that new position.

### Data Track

The system 1 may further provide convenient installation of, and access to, data transmission equipment. To accomplish this, the system 1 may include a data track 100 that may be engaged with the track 10 and installed flush (i.e., within), or substantially flush (i.e., substantially within) with the floor F. As such, in some implementations, the track 10 may be installed within, or substantially within, the floor F during new construction.

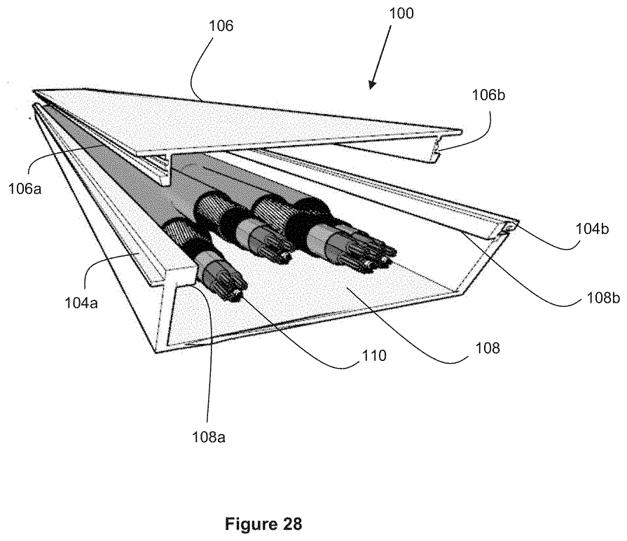

FIG. 28 illustrates a perspective view of a data track 100 that may be engaged with the track 10. The data track 100 may include a base portion 104 and a cover portion 106. The base portion 104 may include a first notched side 104a and a second notched side 104b. The base portion 104 may define an interior channel 108. The interior channel 108 may define a first engaging area 108a and a second engaging area 108b. The cover portion 106 may include a first engaging portion 106a and a second engaging portion 106b. Data equipment 110 may be received within, and routed through, through the interior channel 108 and may be enclosed by the cover portion 106.

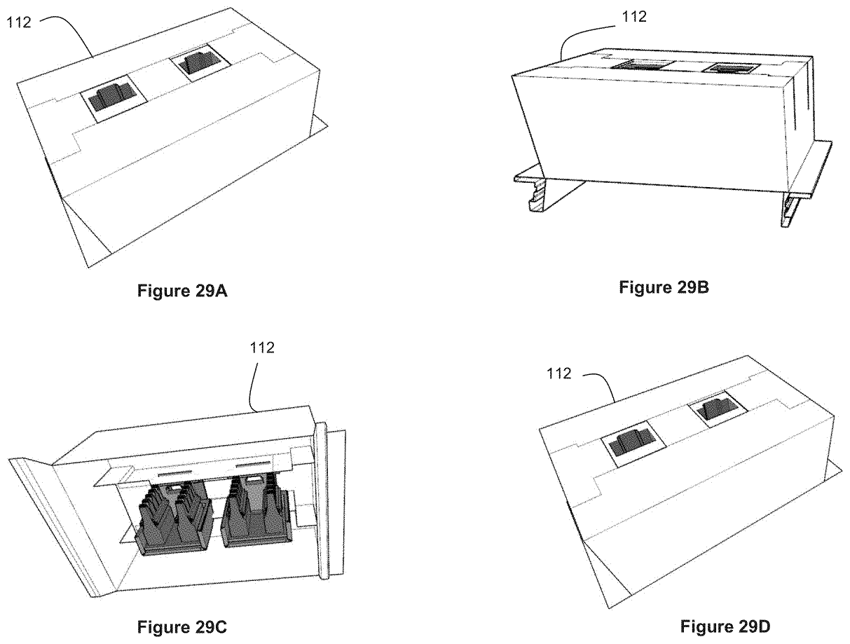

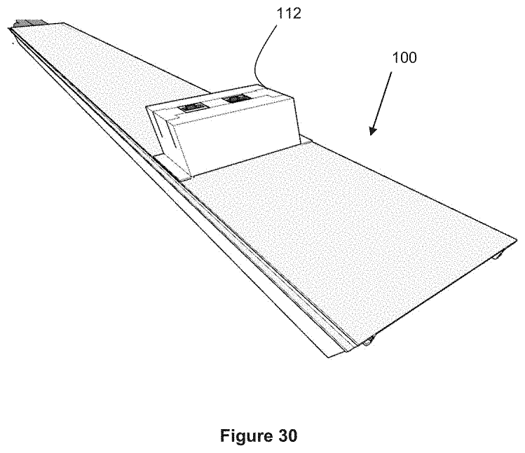

FIG. 29A through 30 illustrate perspective views of conventional registered jack 45s (RJ45s) 112 and an exemplary installation of the RJ45s 112 on the data track 100 where the base portion 104 is engaged with the cover portion 106. The cover portion 106 may be engaged with the base portion 104 via an interference fit connection between the first engaging portion 106a and the first engaging area 108a and an interference fit connection between the second engaging portion 106b and the second engaging area 108b. The RJ45s 112 may be hardwired to a network and may be engaged with a portion of the data track 100 via an interference fit connection.

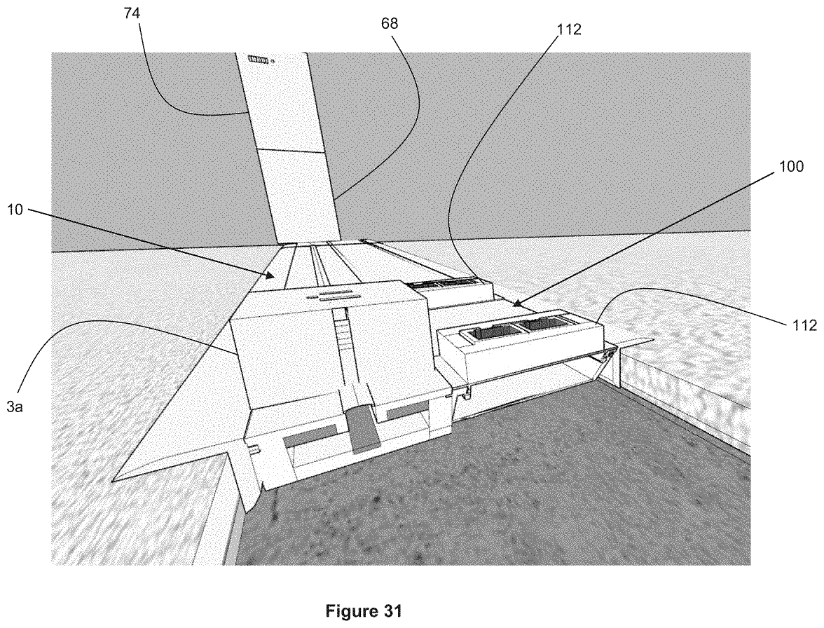

FIG. 31 illustrates a perspective view of the data track 100 engaged with the track 10 and installed within a floor channel FC of the floor F. In the example of FIG. 31, when the data track is engaged with the track 10, one moulding member 46 is engaged with the track 10 and one moulding member 46 is engaged with the data track 100. The data track 100 may be engaged with the second side wall 18 of the track 10. After installation of the data track 100, RJ45 connectors may be connected to a network via the RJ45s 112.

### DEFINITIONS

The following includes definitions of selected terms employed herein. The definitions include various examples or forms of components that fall within the scope of a term and that may be used for implementation. The examples are not intended to be limiting. Both singular and plural forms of terms may be within the definitions.

As used herein, an “operable connection” or “operable coupling,” or a connection by which entities are “operably connected” or “operably coupled” is one in which the entities are connected in such a way that the entities may perform as intended, An operable connection may be a direct connection or an indirect connection in which an intermediate entity or entities cooperate or otherwise are part of the connection or are in between the operably connected entities. In the context of signals, an “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A floor-mounted track for mechanical and electrical engagement of a removable electrical power outlet module, the floor-mounted track comprising:
a bottom rail;
a first rail positioned parallel the bottom rail;
a first electrode engaged with the first rail and extending along at least a portion of a length of the first rail;
a second rail positioned parallel the bottom rail and spaced a distance from the first rail to define a slot between a slot side of the first rail and a slot side of the second rail;
a second electrode engaged with the second rail and extending along at least a portion of a length of the second rail;
a first wall connecting a first side of the bottom rail to a connected side of the first rail opposite the slot side of the first rail; and
a second connecting a second side of the bottom rail to a connected side of the second rail opposite the slot side of the second rail.

2. The floor-mounted track of claim 1, further comprising:
a ground electrode provided on a top surface of the bottom rail.

3. The floor-mounted track of claim 1, further comprising:
a height of the floor-mounted track that is less than one inch in length.

4. The floor-mounted track of claim 1, further comprising:
a height profile of the floor-mounted track relative to a top surface of a floor to which the floor-mounted track is mounted; wherein the height profile is less than 0.0625 inches in length.

5. The floor-mounted track of claim 1, further comprising:
a power input portion including electric terminals configured to connect to power wires, the first electrode and the second electrode electrically connected to the electric terminals and configured to engage the first electrode and second electrode extending from another track portion via connectors formed or installed thereon.

6. The floor-mounted track of claim 5, further comprising:
a lever of the power input portion configured to releasably secure the power input portion proximate the power wires.

7. The floor-mounted track of claim 6, further comprising:
a plate member configured to engage a junction box; and
an opening defined by the plate member; wherein at least a portion of the power input portion extends through the opening; and wherein the lever releasably secures the power input portion to the plate member.

8. The floor-mounted track of claim 5, further comprising:
a plate member configured to engage a junction box;
a bottom surface of the power input portion; and
a notch defined by the bottom surface of the power input portion; wherein the notch engages a portion of the plate member to secure the power input portion to the plate member.

9. The floor-mounted track of claim 5, further comprising:
a transition portion including the first electrode and the second electrode and configured to engage the first electrode and second electrode extending from another track portion via connectors formed or installed thereon; wherein at least a first portion of the first electrode and the second electrode extend in a first direction; and wherein at least a second portion of the first electrode and the second electrode extend in a second direction that is different than the first direction,

10. The floor-mounted track of claim 9, wherein the first direction and the second direction are orthogonal to one another.

11. The floor-mounted track of claim 9, wherein a majority of the first electrode and the second electrode of the power input portion, a majority of the at least a first portion of the first electrode and the second electrode of the transition portion, and a majority of the at least a second portion of the first electrode and the second electrode of the transition portion are coplanar with one another.

12. The floor-mounted track of claim 9, wherein the first electrode and the second electrode of the power input portion and the at least a first portion of the first electrode and the second electrode of the transition portion extend in a parallel direction to one another; and wherein the first electrode and the second electrode of the power input portion and the at least a second portion of the first electrode and the second electrode of the transition portion extend in a perpendicular direction to one another.

13. The floor-mounted track of claim 9, further comprising:
a power track portion including the bottom rail, the first rail, the second rail, the first wall, the second wall, the first electrode, and the second electrode and configured to engage the first electrode and second electrode extending from another track portion via connectors formed or installed thereon.

14. The floor-mounted track of claim 13, further comprising:
an intersection portion including the first electrode and the second electrode and configured to engage the first electrode and second electrode extending from one or more track portions via connectors formed or installed thereon; wherein at least a first part of the first electrode and the second electrode of the intersection portion extend in a third direction; and wherein at least a second part of the first electrode and the second electrode of the intersection portion extend in a fourth direction that is different than the third direction.

15. The floor-mounted track of claim 14, wherein the third direction and the fourth direction are orthogonal to one another.

16. The floor-mounted track of claim 14, wherein the third direction and the fourth direction are parallel to one another.

17. The floor-mounted track of claim 13, further comprising:
an end cap portion including a body and an insertion portion; wherein the insertion portion is inserted within at least a part of the power track portion to seal an end of the power track portion.

18. The floor-mounted track of claim 1, further comprising:
a data track engaged with the floor-mounted track, the data track including:
a base portion and a cover portion;
a notched side of the base portion; and
an interior channel defined by the base portion configured to receive data transmission equipment.

19. The floor-mounted track of claim 1, further comprising:
a moulding engaged with the floor-mounted track, the moulding including:
a first engaging surface and a second engaging surface; wherein the first engaging surface is configured to engage a side of a floor channel of a floor to which the floor-mounted track is mounted to; and wherein the second engaging surface is configured to engage a top surface of the floor.

20. The floor-mounted track of claim 19, further comprising:
a top surface of the moulding; and
a tapered portion of the top surface configured to taper toward and meet the top surface of the floor.

21. The floor-mounted track of claim 1, further comprising:
a flexible first guard member positioned on a side of the slot; and
a flexible second guard member positioned on an opposite side of the slot; wherein the first guard member and the second guard member extend toward one another to cover the slot; and wherein the first guard member and the second guard member allow selective access to the slot.

22. A method for mechanical and electrical engagement of a removable electrical power outlet module to a floor-mounted track, the method comprising:
inserting a stem disposed at a mounting side of the removable electrical power outlet module into a slot of the floor-mounted track;
rotating the removable electrical power outlet to cause engagement of a stem electrode to a first elongated electrode disposed on a bottom side of a first rail of the floor-mounted track and electrically connect a standard AC mains power socket of the removable electrical power outlet module to the first electrode; and
locking the removable electrical power outlet module to the floor-mounted track via a locking mechanism engaging a portion of the floor-mounted track within the slot.
